(19) United States
(12) Patent Application Publication
(10) Pub. No.: US 2026/0202603 A1
(43) Pub. Date: Jul. 16, 2026

(54) ILLUMINATED GLAZING ELEMENT WITH A COATED REFLECTIVE STRUCTURE FOR LIGHT COUPLING

(71) Applicant: SAINT-GOBAIN SEKURIT FRANCE, THOUROTTE (FR)

(72) Inventors: Tobias NIELSEN, HERZOGENRATH (DE); Christy Valerie DE MEYER, HERZOGENRATH (DE)

(21) Appl. No.: 19/137,905

(22) PCT Filed: Oct. 18, 2023
(86) PCT No.: PCT/EP2023/078902

§ 371 Date: Jun. 11, 2025

(30) Foreign Application Priority Data
Dec. 12, 2022 (EP) 22212751.6

(51) Int. Cl. F21V 8/00; B60J 1/20; B60Q 3/208

(52) U.S. Cl. CPC G02B 6/0018; B60J 1/20; B60Q 3/208

(57) ABSTRACT

An illuminated glazing element includes a transparent layer having first and second surfaces and a light source for generating light, arranged in such a way that the light is radiated into the transparent layer via the second surface, wherein a reflective structure having a reflective surface is formed in the first surface or is fastened to the first surface. The reflective surface has a plurality of portions inclined to the second surface and is configured in such that the light radiated into the transparent layer is reflected at the reflective surface and is at least partially coupled back into the transparent layer at an angle of coupling for propagating light in the transparent layer. The reflective surface is provided with a reflective coating including, starting from the reflective surface, in the following order a primer layer and a reflective layer based on a metal or a metal alloy.

The invention relates to an illuminated glazing element and its use.

Illuminated glazing elements are known as such. For illumination, a light source, typically a light-emitting diode, can be arranged on the side edge surface or in a recess of a glass pane of the glazing element, so that light is coupled into the glass pane via the side edge surface or the edge surface of the recess, and propagates there as a result of total reflection. The light is often decoupled from the glass pane again by light-scattering structures, as a result of which illumination is realised. The shape of the light-scattering structures can be freely selected, so that illuminated surfaces of any shape can be generated, for example as a pattern. Illuminated glazing elements of this type are known, for example, from WO2014/060409A1 or WO2014/167291A1.

In the vehicle sector, such illuminated glazing elements are interesting in particular as roof panes through which the interior can be illuminated. The illuminated glass pane is typically the inner pane of a laminated pane. However, such illuminated glazing elements can also be used for other vehicle windows or windows in the building and architectural sector or in furniture. Instead of illuminating an interior, the illuminated surfaces formed by the light-scattering structures can also be used to display information, for example direction arrows, status displays, warnings, price boards or the like.

In the subsequently published international application WO2023144282A1, it was proposed that light should be coupled into the light-guiding layer not via the side edge surface, but via a main surface of the light-guiding layer (for example, a glass pane or light guide plate) of the glazing element. For this purpose, a reflective structure having a reflective surface is attached to or formed in the first surface of the light-guiding layer. The reflective surface has portions that are inclined towards one another. The reflective structure is illuminated by a light source through the light-guiding layer, wherein the light is reflected at the inclined portions of the reflective surface in such a way that it propagates in the light-guiding layer as a result of total reflection at the surfaces. The reflective surface is provided with a reflective coating made of silver or aluminium. The reflective structure can be formed as a microprism film, for example, which is attached to the first surface of the light-guiding layer.

It has been shown that signs of delamination can occur with a microprism film that is provided with a reflective layer made of silver or aluminium. For example, during aging tests, which can comprise exposure to temperature cycles, the microprism film can sometimes detach from the microprism film. This could be caused by a difference in the thermal expansion coefficients of the reflective layer and the microprism film, or by outgassing from the microprism film.

The present invention is based on the object of providing an improved illuminated glazing unit, with which the light from a light source illuminates a reflective structure through a transparent layer and is coupled into the transparent layer by reflection at a reflective surface of the reflective structure. For this purpose, the reflective surface should be provided with a reflective coating that adheres stably and does not detach from the reflective surface, in particular under thermal stress.

The object of the present invention is achieved by an illuminated glazing element according to claim 1. Preferred embodiments result from the dependent claims.

Within the meaning of the invention, the illuminated glazing element is a pane-like or plate-like object that comprises at least one glass pane and, in particular, is structurally formed from at least one glass pane. The glazing element can be a single glass pane and structurally consist only of said glass pane. The glazing element can alternatively be a laminated pane or insulating glazing that contains said glass pane. With a laminated pane, the glass pane is connected to another pane via a thermoplastic intermediate layer. In the case of insulating glazing, the glass pane is connected to another pane via a circumferential spacer in the edge region, as a result of which a space is formed between the panes that is typically filled with inert gas or evacuated. The glazing element can be used as a window pane, for example as a window pane for vehicles, buildings or interiors. However, the glazing element can also be used as a component of furniture or electrical appliances, for example as a door pane of a cupboard or shelf or as a pane of an oven door. The glazing element can also be used as a furnishing item, for example as a display panel in bars or nightclubs.

The illuminated glazing element according to the invention comprises or contains at least one transparent layer and a light source that is intended and suitable for generating light. The transparent layer has a first surface (main surface), a second surface (main surface) and a side edge surface running between them. The light source is arranged in such a way that the light is (at least partially) radiated into the transparent layer via the second surface. The light passes through the transparent layer and hits the first surface.

A reflective structure having a reflective surface is formed in the first surface or is fastened to the first surface. The reflective surface has a plurality of portions inclined to the second surface and is configured in such a way that the light radiated into the transparent layer and passing through the transparent layer is reflected at the reflective surface and is at least partially coupled back into the transparent layer. The light is reflected by the reflective surface into the transparent layer and coupled into it at an angle of coupling that is suitable for the coupled light to propagate at least partially (at least a part of the coupled light) in the transparent layer, in particular by total reflection at the first surface and the second surface of the transparent layer.

To be more precise
the light passes through the transparent layer, strikes the first surface and is reflected there if the reflective structure is formed in the first surface; the reflective surface of the reflective structure is then a partial region of the first surface and the light is reflected from this partial region;
the light passes through the transparent layer, exits the transparent layer again via the first surface and is reflected on the reflective surface of the reflective structure if the reflective structure is fastened to the first surface; preferably, the light exiting the transparent layer passes through the reflective structure and is reflected on its surface facing away from the transparent layer, which forms the reflective surface.

The reflective surface is provided with a reflective coating. According to the invention, the reflective coating comprises at least a primer layer and a reflective layer based on a metal or a metal alloy, which are arranged in the specified order starting from the reflective surface. The primer layer is thus arranged below the reflective layer and the reflective layer above the primer layer. In other words, the primer layer is arranged between the reflective layer and the reflective surface.

In particular the adhesion of the reflective coating to the reflective surface is improved by the primer layer according to the invention. This prevents delamination effects and the reflective coating adheres stably to the reflective surface even after aging tests. The primer layer also acts as a barrier between the reflective structure and the metal-containing reflective layer. As a result, the diffusion of chemical components or oxygen from the reflective structure into the reflective layer is prevented, as a result of which the aging and corrosion of the reflective layer can be effectively reduced. These are great advantages of the present invention.

The different layers of the reflective coating are preferably thin layers. Within the meaning of the invention, this refers to layers with a thickness of less than 1 μm. The thin layers are deposited in particular by means of vapour deposition.

If, within the meaning of the invention, a first layer is deposited above a second layer, this means that it is further from the reflecting surface than the second layer. If a first layer is deposited below a second layer, it is at a smaller distance from the reflective surface than the second layer.

If a layer of the reflective coating is formed based on a material, this means within the meaning of the invention that the majority of the layer consists of the material, i.e. a proportion of at least 50% by weight, preferably at least 70% by weight, particularly preferably at least 90% by weight. The layer can also contain dopants and/or impurities, preferably in a proportion of up to 10% by weight.

The reflective layer of the reflective coating is preferably based on silver or aluminium. Particularly good reflective properties are thus achieved. The proportion of the reflective layer made up of said metal is preferably at least 90%, particularly preferably at least 95%, very particularly preferably at least 99%. The reflective layer can also contain dopants or impurities.

The reflective layer preferably has a thickness of 50 nm to 250 nm. Particularly good reflective properties are thus achieved.

If the reflective layer is formed based on silver, its thickness is preferably 50 nm to 150 nm, particularly preferably 80 nm to 120 nm, for example approximately 100 nm. If the reflective layer is formed based on aluminium, its thickness is preferably 150 nm to 250 nm, particularly preferably 180 nm to 220 nm, for example approximately 200 nm. This is advantageous in terms of reflective properties, without having to use too much material. Within the meaning of the present invention, the thickness always refers to the geometric layer thickness, not the optical layer thickness, which is the product of the geometric thickness and the refractive index.

The primer layer of the reflective coating is preferably formed
based on a nickel alloy, preferably nickel-chromium (NiCr) or nickel-vanadium (NIV),
based on silicon oxide (SiO₂), silicon nitride (Si₃N₄) or silicon oxynitride (SiOₓN_{y}),
based on chromium (Cr) or a chromium alloy,
based on tin (Sn) or a tin alloy,
based on a titanium alloy or an oxide or nitride of a titanium alloy,
based on zinc (Zn) or a zinc alloy, particularly preferably zinc-aluminium (ZnAl),

or
based on copper (Cu) or a copper alloy.

With these materials, good results are achieved with regard to the adhesion of the reflective coating and the barrier effect of the primer layer.

The primer layer preferably has a thickness of 0.5 nm to 10 nm. If the primer layer is formed based on a metal or a metal alloy, in particular selected from the aforementioned metals and metal alloys, its thickness is particularly preferably 0.5 nm to 5 nm, very particularly preferably 1 nm to 3 nm. If the primer layer is formed based on an oxide, nitride or oxynitride, in particular selected from the aforementioned oxides, nitrides and oxynitrides, its thickness is particularly preferably 5 nm to 10 nm.

It is particularly advantageous if the primer layer is formed based on a metal or a metal alloy and is comparatively thin, with a thickness of 0.5 nm to 5 nm, in particular 1 nm to 3 nm. The direction of propagation of the light from the light source is then particularly unaffected. Particularly preferred metals and metal alloys are those mentioned above, i.e.
nickel alloys, in particular nickel-chromium (NiCr) or nickel-vanadium (NIV),
chromium (Cr) or a chromium alloy,
tin (Sn) or a tin alloy,
titanium alloys,
zinc (Zn) or a zinc alloy, in particular zinc-aluminium (ZnAl),

or
copper (Cu) or a copper alloy.

The primer layer is preferably in direct contact with the reflective surface of the reflective structure, and particularly preferably also with the reflective layer.

In an advantageous embodiment, the reflective coating comprises a corrosion protection layer that is arranged above the reflective layer. The reflective layer is thus arranged between the primer layer and the corrosion protection layer. The corrosion protection layer protects the layers located underneath, in particular the reflective layer, from corrosion. This is particularly advantageous if the reflective structure is not stored airtight in the glazing element directly after the reflective coating has been applied, but is initially stored or exposed to air for a prolonged period of time during the production of the glazing element. In such a case, the metal-based reflective layer could corrode, in particular oxidise due to the atmospheric oxygen, which is prevented or at least significantly delayed by the corrosion protection layer.

The corrosion protection layer is preferably formed
based on a nickel alloy, preferably nickel-chromium (NiCr) or nickel-vanadium (NiV),
based on silicon oxide (SiO₂), silicon nitride (Si₃N₄) or silicon oxynitride (SiOₓN_{y}),
based on chromium (Cr) or a chromium alloy,
based on tin (Sn) or a tin alloy,
based on a titanium alloy or an oxide or nitride of a titanium alloy,
based on zinc (Zn) or a zinc alloy, particularly preferably zinc-aluminium (ZnAl),

or
based on copper (Cu) or a copper alloy.

Good results are achieved thereby.

The corrosion protection layer preferably has a thickness of 10 nm to 50 nm, particularly preferably 30 nm to 40 nm. With these thicknesses, good corrosion protection is achieved, without having to use too much material.

A passivating oxide layer can form on the (exposed) surface of the corrosion protection layer (facing away from the reflective layer), in particular if the corrosion protection layer is formed based on a metal or a metal alloy.

In principle, the reflection layer can have other layers. In a preferred embodiment, however, the reflective layer is in direct contact with the primer layer (and the corrosion protection layer, if present). Above the electrically conductive layer (if no corrosion protection layer is present) or above the corrosion protection layer (if such a layer is present), a further layer can be provided that, for example, improves the connection to neighbouring components of the glazing element or serves as a barrier to it.

It is particularly preferred that the reflection layer consists only of the layers mentioned here (primer layer, electrically conductive layer, optional corrosion protection layer) and has no further layers. Thus, the reflection layer preferably consists exclusively of the primer layer and the reflective layer or of the primer layer, the reflective layer and the corrosion protection layer.

The transparent layer of the glazing element can also be referred to as a transparent coating, a light-guiding layer or a light-guiding coating. In particular, it is a transparent glass or polymer layer. The transparent layer is preferably a rigid layer. For example, it can be formed as a glass pane or plate or as a plastic pane or plate. The glass pane or plastic pane can form an outer pane of the glazing element that is exposed to the environment or can be embedded in the glazing element as a light guide plate. A flexible light guide film can also be embedded in the glazing element and act as a transparent layer, for example a PET foil with a thickness of 30 umm to 200 μm. The transparent layer has the task of distributing the light radiated by the light source over the surface of the glazing element in the manner of a light guide.

The defining transparency of the transparent layer refers in particular to the wavelength or wavelength range of the light source. The transparent layer preferably has a light transmission relative to the light from the light source of at least 70%, particularly preferably at least 80%, very particularly preferably at least 90%.

The first surface of the transparent layer faces away from the light source; the second surface of the transparent layer faces the light source. The light source illuminates the transparent layer, wherein the light enters the transparent layer via the second surface, passes through the transparent layer and strikes the first surface of the transparent layer.

The second surface is formed to be particularly smooth (flat or curved). The first surface is preferably also formed to be smooth and arranged parallel to the second surface—with the exception of the region of the reflective surface, if the reflective structure is formed directly in the first surface.

The reflective structure serves to couple light into the transparent layer. It is arranged opposite the light source on the first surface of the transparent layer, in particular fastened to the first surface of the transparent layer, or formed in the first surface, so that the light passing through the transparent layer strikes the reflective structure and is (at least partially) reflected back in the direction of the transparent layer by its reflective surface, which is provided with the reflective coating.

Typically, not the entire first surface of the transparent layer is provided with the reflective structure, but only a partial region of the first surface that is illuminated by the light source.

The reflective structure can comprise or be formed from a separate component of the glazing unit, in particular a microprism film. The component is attached to the first surface, for example glued on. The reflective surface of the reflective structure faces away from the transparent layer. The component is transparent. The light from the light source exits the transparent layer again via the first surface, passes through the component and strikes its reflective surface, where it is reflected and passes through the component again and re-enters the transparent layer via the first surface.

A microprism film is a flexible, in particular foil-like polymer film that has a smooth surface facing the transparent layer and in particular arranged on same, and a structured surface facing away from the transparent layer. The structured surface is in the form of a planar arrangement of a plurality of prisms with dimensions in the micrometer range, wherein the prism surfaces form the inclined portions of the reflective surface. The microprisms (provided with the reflective coating) act in particular as reflective prisms and reflect the light that strikes them in a direction that depends on the angle of inclination of the prism surfaces and the angle of incidence of the light. Microprism films are commercially available and can be purchased or produced during the production of the glazing element according to the invention. The edge length of the individual microprisms is preferably from 10 μm to 250 μm, particularly preferably from 20 μm to 100 μm, for example approximately 30 μm.

The microprism film can be formed to be multi-layered. For example, microprism films are commonly used which have a substrate layer, for example based on polyethylene terephthalate (PET), on which the microprisms are formed from a UV-curing polyacrylate.

The microprism film is transparent and preferably has a light transmission of at least 70° relative to the light from the light source, particularly preferably at least 80°, very particularly preferably at least 90°. It is advantageous if the difference between the refractive indices of the transparent layer and the microprism film is as small as possible in order to minimise reflection losses at the interface between the transparent layer and the microprism film. Preferably, said difference in refractive indices is at most 0.02 (based on a wavelength of 550 nm), particularly preferably at most 0.01. If the transparent layer and the microprism film differ in refractive index, the microprism film preferably has a higher refractive index than the transparent layer, which is advantageous for light coupling with a high yield.

Instead of a flexible microprism film, a rigid microprism plate can also be used, i.e. a rigid plastic plate with a planar arrangement of microprisms.

However, the reflective structure can also be formed directly in the first surface of the transparent layer. For this purpose, a partial region of the first surface is formed as a reflective surface. This is comparatively easy to realise, particularly if the transparent layer is a polymer layer, such as a plastic pane or plate. The light is reflected directly at the first surface and reflected back into the transparent layer, without exiting the transparent layer. If the reflective surface with the reflective coating is formed to be only partially reflective, some of the light naturally exits the transparent layer via the first surface and is not reflected.

According to the invention, the reflective surface of the reflective structure has portions that are inclined towards the second surface of the transparent layer. This means that the portions are not arranged parallel to the second surface, but at an angle of greater than 0° to the second surface. Said portions are arranged at an angle to the second surface of between 0° and 90°, preferably from 28° to 60° or from 30° to 60°, very particularly preferably from 30° to 50°, in particular from 40° to 50°, for example approximately 45°. This refers to the absolute value of the particular angle. The portions can be inclined in different directions.

The portions are also preferably inclined towards one another. This means that neighbouring portions are inclined to one another, i.e. they are not arranged parallel to one another, but at an angle between 0° and 180° to one another.

Said portions of the reflective surface are preferably substantially flat. The inclination of the portions of the reflective surface to the second surface of the transparent layer determines the angle at which the reflected light is reflected back into the transparent layer.

The first and second surfaces of the transparent layer represent interfaces to the adjacent medium, either to the surrounding atmosphere or to another layer or coating of the glazing element. Typically, the adjacent medium has a different refractive index from the transparent layer. In the event that the adjacent medium has a lower refractive index than the transparent layer, this results in a critical angle of total reflection, which is determined as

$${α}_{T} = arcsin ( \frac{{n}_{2}}{{n}_{1}} ) ,$$

where n₁ is the refractive index of the transparent layer and n₂ is the refractive index of the adjacent medium.

In particular, the portions of the reflective surface are inclined in such a way that at least a part of the light is reflected back into the transparent layer with an angle of coupling such that it strikes the second surface at an angle (angle of incidence) that is greater than the critical angle of total reflection. The light beam is totally reflected at the second surface with an angle of reflection that corresponds to the angle of incidence. The light strikes the first surface at this angle of incidence, where it is in turn totally reflected. The light does not pass into the surroundings and propagates substantially loss-free in the transparent layer as a result of repeated total reflection, wherein it is reflected back and forth between the two surfaces of the transparent layer. As is usual in geometric optics, the angle of incidence is the angle that the light beam incident on the surface has to the surface normal of the surface at the point of impact. The angle of reflection is also determined analogously to the surface normal, as is the critical angle of total reflection.

In certain embodiments of the invention, the medium adjacent to the first surface of the transparent layer is different from the medium adjacent to the second surface. This is the case with laminated panes, for example, which consist of two laminated glass panes, wherein one of the glass panes is used as a transparent layer. Then, one of the surfaces of said glass pane is adjacent to the surrounding atmosphere and the other surface is adjacent to the thermoplastic intermediate layer of the laminated pane. Therefore, different critical angles of total reflection occur on the two surfaces. In this case, the reflective surface is formed in such a way that at least a part of the light is reflected back into the transparent layer with such an angle of coupling that it strikes the second surface at an angle (angle of incidence) that is greater than the larger critical angle of total reflection. These light components propagate in the transparent layer as a result of repeated total reflection on both surfaces.

The light propagates in the transparent layer until it either strikes the side edge surface of the transparent layer and is decoupled there or strikes a light-scattering structure on one of the two surfaces of the transparent layer, which interrupts the total reflection by light scattering, as a result of which the light is decoupled from the transparent layer via the relevant surface.

The glazing element is provided with a light source that is suitable for coupling light into the glass pane. During operation, the light source emits visible light, i.e. electromagnetic radiation in the visible spectral range, in particular in the range from 380 nm to 780 nm. The light source can have one or more emission bands, which is or are arranged in the visible spectral range and covers or cover a part thereof. However, the light source can also have a broad emission band that covers the entire visible spectral range. The emission band(s)—and thus the colour of the emitted light—can be freely selected according to the requirements of the specific application.

The glazing element can have a single light source or a plurality of separate light sources whose light is coupled into the transparent layer at different points.

The light source preferably comprises at least one light-emitting diode (LED). The light source can be a single light-emitting diode, but is preferably an arrangement of a plurality of light-emitting diodes. Said arrangement is preferably installed in a common housing, for example as a linear arrangement with which the light-emitting diodes are arranged along a line. The electroluminescent material of the light-emitting diode can be an inorganic semiconductor or an organic semiconductor, for example. In the latter case, it is also referred to as an organic light emitting diode (OLED).

The light from the light source can be radiated into the glazing unit directly or via an optical element, such as a lens. In an advantageous embodiment, the light from the light source is radiated into the glazing element or transparent layer via a collimator. The collimator generates a light beam from the typically divergent light beam of the light source, preferably with a substantially parallel beam path, but at least with a less divergent, i.e. more concentrated beam path. This has the advantage that the entire light beam is radiated into the glazing element with the same angle of incidence, in particular with an angle of incidence that, in conjunction with the inclination of the portions of the reflective surface of the reflective structure, ensures that the largest possible proportion of the light is coupled into the transparent layer in such a way that total reflection occurs at the surfaces. As a result, the light output is optimised.

In the simplest case, the collimator is a type of converging lens with the light source at its focal point. The collimator can, for example, be formed from glass or a transparent plastic, in particular polycarbonate (PC) or polymethyl methacrylate (PMMA). If the light source is formed as an arrangement of a plurality of light-emitting diodes, a separate collimator can be provided for each light-emitting diode. Preferably, however, a common collimator is used for the entire LED arrangement. In the case of a linear LED arrangement, for example, a rod-like collimator can be used, the length of which corresponds at least to the length of the LED arrangement.

If the glazing element is a laminated pane, the collimator is preferably attached, for example glued, to the exposed (interior-side) surface of the inner pane. The light source is attached to the surface of the collimator facing away from the laminated glass, for example glued on, screwed on or snapped into the collimator. If the glazing element is a monolithic pane, in particular a single glass pane, the collimator is preferably attached to the second surface, for example glued on.

The collimated light beam is preferably radiated into the glazing element with an angle of incidence not equal to 0°. The angle of incidence is determined as the angle to the surface normal on the exposed surface of the glazing element facing the light source, for example the interior-side surface of the inner pane of a laminated pane. The angle of incidence is selected in such a way that the largest possible proportion of the light (preferably substantially all of the light) is coupled into the transparent layer in such a way that total reflection occurs on the surfaces of the transparent layer and the light thus propagates in the transparent layer. The suitable angle of incidence lies in an angular range that is largely dependent on the refractive indices of the media adjacent to the transparent layer (similar to the numerical aperture of a light guide). The suitable angle of incidence also depends on the orientation of the inclined portions of the reflective surface relative to the light source and (in the case of a separate component with the reflective surface, in particular a microprism film), also on the refractive index of the material of said component. The orientation (inclination) of the portions of the reflective surface of the reflective structure determines the direction of the reflected light (angle of incidence corresponds to angle of reflection). The suitable angle of incidence can be selected by a person skilled in the art for the specific application using simple optical calculations.

An angle of incidence not equal to 0° is realised, for example, by the surface of the collimator facing the transparent layer not being arranged in a manner parallel to the surface facing the light source to which the light source is fastened.

In a preferred embodiment, the transparent layer according to the invention is provided with at least one light-scattering structure, which is suitable for decoupling the light from the transparent layer via its first surface and/or via its second surface. The light-scattering structure is arranged on the first or second surface or is in contact with one of these surfaces. If the light propagating in the transparent layer strikes the light-scattering structure, it is scattered, as a result of which total reflection is prevented, so that the scattered light is decoupled and leaves the transparent layer.

The light-scattering structure appears as a luminous surface of the glazing element. This can be used, for example, to illuminate an interior or to display symbols or patterns that serve to convey information or may be provided for purely aesthetic reasons. The light-scattering structure can be present in a single continuous region of the glass pane or in a plurality of separate regions. Due to the light-scattering structure, any shape or pattern can be realised.

The light-scattering structure can be applied directly to the first or second surface of the transparent layer or formed there. Alternatively, the light-scattering structure can be provided, for example, on a carrier foil that is fastened to the first or second surface, for example by adhesive bonding. If the glazing element according to the invention is a laminated pane, the light-scattering structure can be applied to the surface of a thermoplastic intermediate layer in contact with the transparent layer. Alternatively, the light-scattering structure (applied to a carrier foil, for example) can be inserted between the transparent layer and the intermediate layer.

In an advantageous embodiment, the light-scattering structure is formed as an imprint, in particular as an imprint on one of the surfaces of the transparent layer or—in the case of a laminated pane—on the surface of the adjacent intermediate layer facing the transparent layer. If the transparent layer is made of glass (e.g., the inner pane of a laminated pane or an embedded light guide plate made of glass), an imprint on this is preferably formed as light-scattering enamel. This enamel can, for example, be applied using a screen printing method. It preferably contains glass frits, which are burned into the surface of the glass layer, as a result of which a roughened and therefore light-scattering surface is created. An imprint on a polymer layer (for example, an intermediate layer or a polymer light guide plate) can be realised by printing a surface of the polymer layer with a light-scattering printing paste, for example using a screen printing method. In an advantageous embodiment, the light-scattering structure is transparent so that it does not significantly restrict seeing through the glazing element. The imprint (the enamel or printing paste) therefore preferably contains no pigment. However, opaque or semi-transparent light-scattering structures with pigments, for example white structures, are also conceivable.

However, light-scattering structures can also be formed by roughening the relevant surface of the transparent layer. This roughening can be carried out mechanically (e.g., by grinding techniques) or by laser processing. Laser processing has the advantage, in particular in the case of a laminated pane, that the light-scattering structure can also be introduced into the finished laminated pane, even if it is to be located inside the laminated pane, since the laser radiation can also be focused on a plane inside the laminated pane. Laser processing also makes it possible to form the light-scattering structure inside the transparent layer rather than on the surface.

However, the light-scattering structure is not absolutely necessary within the framework of the present invention. Applications are also conceivable with which light decoupling is to be carried out via the side edge surface of the transparent layer, wherein no light-scattering structures are required on the first or second surface.

The glazing element can be a monolithic pane, in particular a single glass pane. Structurally, the glazing element is formed exclusively by a single glass pane, which also acts as a transparent layer within the meaning of the invention. The glass pane has a thickness of 1 mm to 10 mm, for example, and is preferably made of soda lime glass. The glass pane is preferably made of clear glass without tinting or colouring. The single glass pane is typically used as a window pane for demarcating an interior from an external environment. It has an interior-side surface that faces the interior in the installed position and an outer-side surface that faces the external environment in the installed position. The interior-side surface is preferably the second surface within the meaning of the invention and the light source is fastened to it. The outer-side surface is the first surface within the meaning of the invention and is provided with the reflective structure. Instead of a single glass pane, in principle a single polymer pane made of a clear transparent plastic can also be used.

In an advantageous embodiment, however, the glazing element according to the invention is formed as a laminated pane. The laminated pane according to the invention comprises an outer pane and an inner pane, which are connected to one another via a thermoplastic intermediate layer. The outer pane and the inner pane in each case have an interior-side surface that faces the interior in the installed position and an outer-side surface that faces the external environment in the installed position. The outer-side and interior-side surfaces are typically provided to be seen through, with a side edge surface extending between them. The interior-side surface of the outer pane and the outer-side surface of the inner pane face one another and are connected to one another by the at least one intermediate layer. The outer pane and the inner pane are preferably made of glass, in particular soda lime glass, and in each case have a thickness of 0.5 mm to 10 mm, preferably 1 mm to 5 mm. The intermediate layer (or each intermediate layer, if there is a plurality) is preferably formed from a thermoplastic foil, for example based on polyvinyl butyral (PVB), ethylene vinyl acetate (EVA) or polyurethane (PU), and has a thickness of, for example, 0.3 mm to 1.0 mm. Instead of glass panes, in principle polymer panes made of a clear transparent plastic can also be used as the outer pane and/or inner pane. The light source is preferably fastened to the interior-side surface of the inner pane.

If a polymeric foil or layer is formed based on a material, this means within the meaning of the invention that the majority of the foil or layer consists of the material, i.e. the proportion of the material is more than 50% by weight, preferably more than 60% by weight. The foil or layer can also contain other components, such as plasticisers, stabilisers, UV or IR blockers.

The inner pane is preferably formed from clear glass, in order to ensure efficient light penetration. The outer pane and the intermediate layers between the transparent layer and the outer pane can be tinted or coloured.

In a first preferred variant of the laminated pane, the outer pane or the inner pane is the transparent layer within the meaning of the invention, particularly preferably the inner pane. The interior-side surface of the inner pane (or outer pane) is in particular the second surface within the meaning of the invention; the outer-side surface is the first surface, which is provided with the reflective structure. The reflective structure preferably comprises or is formed from a separate component, in particular a microprism film. The component is preferably fastened to the outer-side surface of the inner pane (or outer pane). The component can be glued to the surface or (in the case of the inner pane) fixed there by the contact pressure of the at least one intermediate layer.

In a second preferred variant, the laminated pane has a light guide plate that is arranged between two intermediate layers. The at least two intermediate layers and the light guide plate are arranged between the outer pane and the inner pane. The light guide plate is the transparent layer within the meaning of the invention, wherein the first surface within the meaning of the invention is preferably the outer-side surface of the light guide plate and the second surface is the interior-side surface. In one embodiment, the light guide plate is a glass pane, in particular a comparatively thin glass pane with a thickness of 0.2 mm to 3 mm, preferably 0.5 mm to 2.1 mm, for example 0.5 mm to 1 mm. In a further embodiment, the light guide plate can be a polymer light guide plate, preferably made of a clear, rigid plastic such as polycarbonate (PC) or polymethyl methacrylate (PMMA), for example with a thickness in the ranges specified above for the glass light guide plate.

Instead of the light guide plate, the laminated pane can also have a flexible light guide film (light guide foil) as a transparent layer.

The reflective structure can comprise or be formed from a separate component, in particular a microprism film. The component is fastened to the first surface of the light guide plate, in particular the outer-side surface. The component can be glued to the light guide plate or fixed there by the contact pressure of the adjacent intermediate layer.

Alternatively, the reflective structure can be formed directly in the first surface of the light guide plate (in its function as a transparent layer). This is particularly easy to realise if the light guide plate is formed from plastic. The reflective surface with the inclined surfaces can, for example, be generated by removing material in a region of the first surface, for example by milling or grinding, by laser processing or by chemical processing such as etching. Alternatively, the reflective surface can be formed by additionally applying polymeric material to the first surface, for example made of UV-curing polyacrylate.

The laminated pane preferably has an opaque masking region through which it is not possible to see. This masking region is preferably arranged circumferentially in an edge region of the laminated pane and surrounds a central transparent see-through region like a frame. This is particularly common for vehicle windows. The masking region is formed in particular by an opaque element, which is arranged on the outer side of the reflective structure, preferably between the reflective structure and the outer pane. The masking region can be formed by an opaque cover imprint, which is particularly preferably applied to the interior-side surface of the outer pane. Alternatively, a tinted intermediate layer (or a tinted portion of an intermediate layer) can form said opaque element.

The glazing element can be flat or curved in one or more directions of the space.

The reflective coating is preferably deposited on the reflective surface by vapour deposition, for example by chemical vapour deposition (CVD), plasma-enhanced chemical vapour deposition (PECVD) or atomic layer deposition (ALD). Physical vapour deposition (PVD), for example evaporation deposition, is particularly preferred, cathode sputtering (“sputtering”) and in particular magnetic field-assisted cathode sputtering (“magnetron sputtering”) are very particularly preferred.

If the glazing element is formed as a laminated pane, known methods for lamination can be used to produce it, for example autoclave methods, vacuum bag methods, vacuum ring methods, calendering methods, vacuum laminators or combinations thereof. The outer pane and inner pane are usually connected under the effect of heat, vacuum and/or pressure.

The invention also comprises the use of a glazing element according to the invention as a window pane of a vehicle. A particularly preferred application is a vehicle roof pane, which is used for illuminating the vehicle interior. In principle, the vehicle can be any land vehicle, watercraft or aircraft, and is preferably a passenger car, truck or rail vehicle. The glazing element can also be used in buildings, for example as a window pane, glass façade or glass door in exterior or interior areas, in particular as a window pane of a building or an interior. The glazing element can also be used as a component of furniture, electrical appliances, as a component of furnishings or as a furnishing item.

In the following, the invention is explained in more detail with the aid of a drawing and examples of embodiments. The drawing is a schematic representation and is not true to scale. The drawing does not limit the invention in any way.

In the drawings:

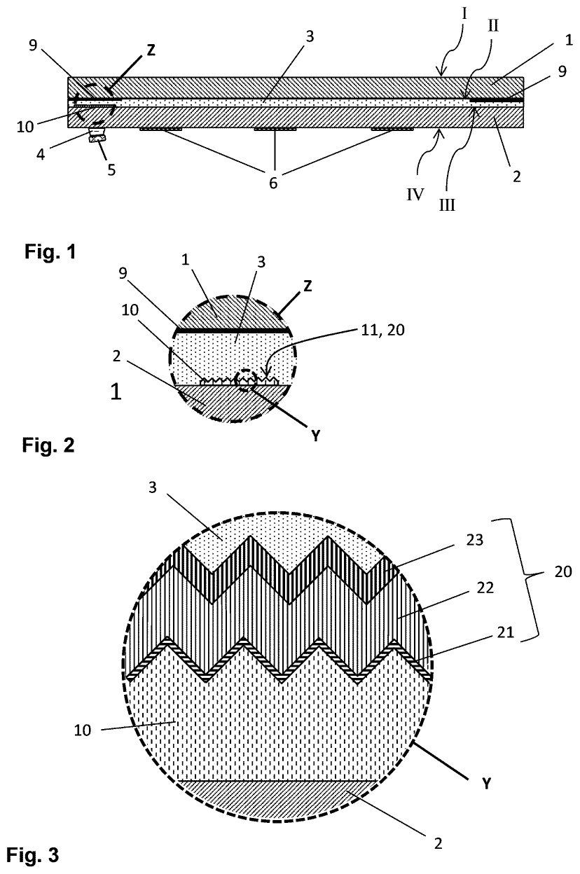

FIG. 1 is a cross-section through an embodiment of the pane according to the invention,

FIG. 2 is an enlarged section Z from FIG. 1,

FIG. 3 is a further enlarged section Y from FIG. 2,

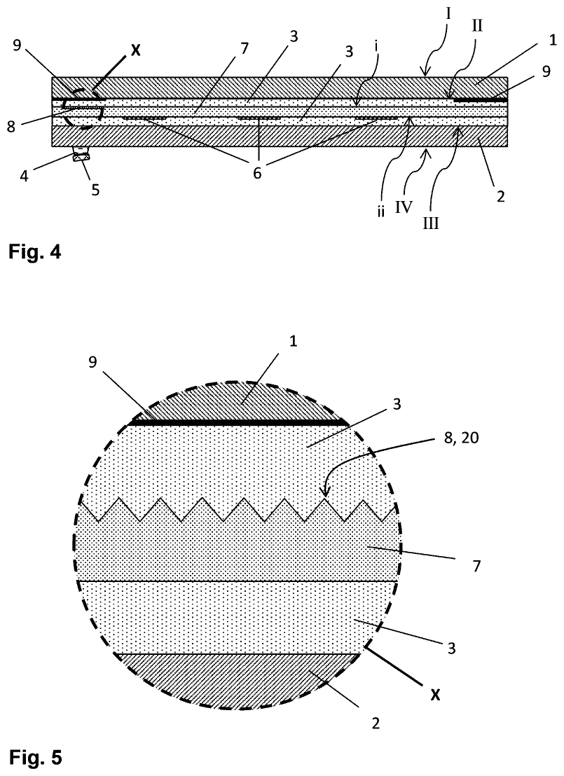

FIG. 4 is a cross-section through a further embodiment of the glazing element according to the invention,

FIG. 5 is an enlarged section X from FIG. 4.

FIG. 1, FIG. 2 and FIG. 3 in each case show a detail of an initial embodiment of the glazing element according to the invention. FIG. 1 shows a cross-section of the glazing element. A section Z is marked there, which is shown enlarged in FIG. 2. There, in turn, a section Y is marked, which is shown enlarged in FIG. 3.

The glazing element is formed as a laminated pane. The laminated pane is intended, for example, as the roof pane of a vehicle, in particular a passenger car. For the sake of simplicity, it is shown flat, although such vehicle roof panes are typically curved. The laminated pane is constructed from an outer pane 1 and an inner pane 2, which are connected to one another via a thermoplastic intermediate layer 3. The outer pane 1 and the inner pane 2 consist of soda lime glass and have a thickness of, for example, 2.1 mm in each case. The intermediate layer 3 is formed from a PVB foil with a thickness of, for example, 0.76 mm. The inner pane 2 is clear, the outer pane 1 and the intermediate layer 3 are tinted in order to reduce the light transmission of the laminated pane (for example, to less than 15%), as is usual for vehicle roof panes.

In the installed position, the outer pane 1 faces the external environment of a vehicle. It has an outer-side surface I that faces the external environment and an interior-side surface II that faces the vehicle interior. In the installed position, the inner pane 2 faces the vehicle interior. It has an outer-side surface Ill that faces the external environment and an interior-side surface IV that faces the vehicle interior.

The laminated pane has a circumferential, opaque edge region, in which a black cover imprint 9 is applied to the interior-side surface II, which prevents the laminated pane from being seen through. In this edge region, a light source 5 is fastened to the interior-side surface IV of the inner pane 2 via a collimator 4. The light source 5 is, for example, a linear arrangement of a plurality of LEDs. The collimator 4 generates a directed, more concentrated light beam from the divergent radiation of the LEDs. The light strikes the inner pane 2 at an angle of incidence of, for example, 22° (measured relative to the surface normal of the interior-side surface IV) and with a full width at half maximum of +/−4°.

The inner pane 2 acts as a transparent layer within the meaning of the invention. It is provided as a planar light guide. For this purpose, the light emitted by the light source 5 through the inner pane 3 is coupled into the inner pane 2. The outer-side surface III of the inner pane 3 is provided with a reflective structure for this purpose, which is illuminated by the light from the light source 5. The reflective structure is a microprism film 10, which is applied to a partial region of the outer-side surface III. The surface of the microprism film 10 facing away from the inner pane 2 acts as the reflective surface 11 of the microprism film 10. It is formed in the shape of a planar arrangement of microprisms and therefore has a plurality of portions that are inclined in different directions relative to the inner pane 2 (and its surfaces III, IV), for example at an angle of approximately 45° (the “roof angle” between neighbouring portions inclined relative to one another is) 90°.

The microprism film 10 is composed of two layers, for example: a PET carrier layer facing the inner pane 2 and a layer of a UV-curing polyacrylate from which the microprisms are formed on the carrier layer.

The light passing through the inner pane 2 passes through the microprism film 10 and strikes the reflective surface 11. There, it is reflected back in the direction of the inner pane 2. Depending on the inclination of the portions of the reflective surface 11, the light is deflected during reflection and radiated into the inner pane 2 in such a way that (after transmission through the inner pane 2) it strikes the interior-side surface IV with an angle of incidence (measured relative to the surface normal) that is greater than the largest occurring critical angle of total reflection of the inner pane 2. This largest critical angle occurs on the outer-side surface III, since the difference between the refractive index of the inner pane and the refractive index of the adjacent medium (PVB intermediate layer 3) is smallest here. At a wavelength of 520 nm, for example, the refractive index of the inner pane 2 is 1.53 and the refractive index of the intermediate layer 3 is 1.48. This results in a critical angle of total reflection of 75.31°.

The light then propagates in the inner pane 2 in the manner of a light guide, wherein it is reflected back and forth between the surfaces III, IV (total reflection in each case).

Light-scattering structures 6 made of transparent enamel are printed on the interior-side surface IV in order to decouple the light from the inner pane 2 and thus realise illumination. If the light strikes these light-scattering structures 6, it is scattered and thus decoupled from the inner pane 2. The light-scattering structures 6 thus appear to an observer as luminous surfaces, which can be used for lighting, for example, or can display symbols or patterns.

Since the refractive index difference between the microprism film 10 and the intermediate layer 3 is not sufficiently pronounced for efficient reflection of the incident light, the reflective surface 11 is provided with a reflective coating 20. The reflective coating 20 is composed of (in this order, starting from the microprism film 10) a primer layer 21, a reflective layer 22 and a corrosion protection layer 23.

The primer layer 21 is, for example, a 1 nm thick layer of nickel-vanadium (NiV). The reflective layer 22 is, for example, a 100 nm thick layer of silver (Ag). The reflective layer 22 provides the reflective properties of the reflective coating 20. The primer layer 21 primarily improves the adhesion of the reflective layer 22 to the microprism film 10. Due to the primer layer 21, no delamination (detachment) of the reflective layer 22 occurs even under thermal stress. The primer layer 21 also acts as a barrier between the microprism film 10 and the reflective layer 21, so that in particular the diffusion of chemical components of the microprism film 10 into the reflective layer 21 is prevented.

Within the framework of the present invention, the corrosion protection layer 23 is optional. It is, for example, a 25 nm thick layer made of copper (Cu), wherein a passivating layer made of copper oxide may have formed on the surface. The task of the corrosion protection layer 23 is to protect the reflective layer 22 from corrosion if the microprism film 10 is exposed to air for a prolonged time before the laminated pane is produced.

FIG. 4 and FIG. 5 each show a detail of a laminated pane according to the invention. FIG. 4 shows a cross-section of the glazing element. A section Z is marked there, which is shown enlarged in FIG. 5.

The glazing element is again formed as a laminated pane. The outer pane 1 with the cover imprint 9 and the inner pane 2 with the light source 5 and the collimator 4 are formed in exactly the same way as in the embodiment according to FIG. 1.

In contrast to the embodiment according to FIG. 1, however, it is not the inner pane 2 that serves as the transparent layer within the meaning of the invention, but a light guide plate 7, which is arranged between two thermoplastic intermediate layers 3. The intermediate layers 2 are in turn in each case formed from a PVB foil with a thickness of 0.38 mm or 0.76 mm, for example. The intermediate layer 3 adjacent to the inner pane 2 is clear, while the intermediate layer 3 adjacent to the outer pane 1 is tinted.

The light guide plate 7 is, for example, a plastic pane made of polycarbonate with a thickness of 0.7 mm. It has a first, outer-side surface i, which faces the external environment and the outer pane 1, and a second, interior-side surface ii, which faces the vehicle interior and the inner pane 2.

The light is radiated from the light source 5 through the inner pane 2, the adjacent intermediate layer 3 and the light guide plate 7 and coupled back into the light guide plate 7 via the outer-side surface i. For this purpose, a microprism film 10 can be arranged on the outer-side surface i. In the embodiment shown, however, the reflective structure with the reflective surface 8 is formed directly in the outer-side surface i of the light guide plate. The inclined portions of the reflective surface 8 are embossed into the outer-side surface i, for example. The reflective surface 8 is provided with the reflective coating 20, which is formed in the same way as in the embodiment of FIG. 3.

The light passing through the light guide plate 7 is reflected on the outer-side surface i by the reflective surface 8, which forms a partial region of the outer-side surface i. Due to the inclined portions of the reflective surface 8, this light coupling is carried out at such an angle that the light is totally reflected at surfaces i, ii and thus propagates in the light guide plate 7.

For decoupling the light, the light-guiding structures 6 are arranged on the interior-side surface ii of the light guide plate 7.

### LIST OF REFERENCE SIGNS

(1) Outer pane
(2) Inner pane
(3) Thermoplastic intermediate layer
(4) Collimator
(5) Light source
(6) Light-scattering structure
(7) Light guide plate
(8) Structured, reflective surface of the light guide plate 7
(9) Cover imprint
(10) Microprism film
(11) Reflective surface of the microprism film 10
(20) Reflective coating
(21) Primer layer of the reflective coating 20
(22) Reflective layer of the reflective coating 20
(23) Corrosion protection layer of the reflective coating 20
(I) First/outer-side surface of the outer pane 1
(II) Second/interior-side surface of the outer pane 1
(III) First/outer-side surface of the inner pane 2
(IV) Second/interior-side surface of the inner pane 2
(i) First/outer-side surface of the light guide plate 7
(ii) Second/interior-side surface of the light guide plate 7
Z Enlarged section
Y Enlarged section
X Enlarged section

1. An illuminated glazing element, comprising a transparent layer having a first surface and a second surface and a light source for generating light, which is arranged in such a way that the light is radiated into the transparent layer via the second surface,
wherein a reflective structure having a reflective surface is formed in the first surface or is fastened to the first surface, wherein the reflective surface has a plurality of portions inclined to the second surface and is configured in such a way that the light radiated into the transparent layer is reflected at the reflective surface and is at least partially coupled back into the transparent layer at an angle of coupling that is suitable for the coupled light to propagate in the transparent layer,
and wherein the reflective surface is provided with a reflective coating that comprises, starting from the reflective surface, in the following order:
a primer layer and
a reflective layer based on a metal or a metal alloy.

2. The illuminated glazing element according to claim 1, wherein the reflective layer is formed based on silver or aluminium.

3. An illuminated glazing element according to claim 1 or 2, wherein the reflective layer has a thickness of 50 nm to 250 nm.

4. The illuminated glazing element according to claim 1, wherein the primer layer is formed based on a nickel alloy, based on silicon oxide, silicon nitride or silicon oxynitride, based on chromium or a chromium alloy, based on tin or a tin alloy, based on a titanium alloy or an oxide or nitride of a titanium alloy, based on zinc or a zinc alloy, or based on copper or a copper alloy.

5. The illuminated glazing element according to claim 1, wherein the primer layer has a thickness of 0.5 nm to 10 nm.

6. The illuminated glazing element according to claim 1, wherein a corrosion protection layer is arranged above the reflective layer.

7. The illuminated glazing element according to claim 6, wherein the corrosion protection layer is formed based on a nickel alloy, based on silicon oxide, silicon nitride or silicon oxynitride, based on chromium or a chromium alloy, based on tin or a tin alloy, based on a titanium alloy or an oxide or nitride of a titanium alloy, based on zinc or a zinc alloy, or based on copper or a copper alloy.

8. The illuminated glazing element according to claim 6, wherein the corrosion protection layer has a thickness of 10 nm to 50 nm.

9. The illuminated glazing element according to claim 1, which is formed as a laminated pane and comprises an outer pane and an inner pane, which are connected to one another via at least one thermoplastic intermediate layer.

10. The illuminated glazing element according to claim 9, wherein the inner pane is the transparent layer.

11. The illuminated glazing element according to claim 9, wherein the transparent layer is a light guide plate that is arranged between two intermediate layers.

12. The illuminated glazing element according to claim 10, wherein the reflective structure is formed as a microprism film that is fastened to the first surface.

13. The illuminated glazing element according to claim 11, wherein the reflective structure is formed in the first surface of the light guide plate.

14. The illuminated glazing element according to claim 1, wherein the light is radiated into the transparent layer via a collimator.

15. A method comprising providing an illuminated glazing element according to claim 1 as a window pane of a vehicle, a building or an interior, as a component of furniture, electrical appliances, as a component of furnishings or as a furnishing item.

16. The illuminated glazing element according to claim 1, wherein the coupled light propagates in the transparent layer by total reflection at the first surface and the second surface.

17. The illuminated glazing element according to claim 4, wherein the nickel alloy is nickel-chromium or nickel-vanadium, and the zinc alloy is zinc-aluminium.

18. The illuminated glazing element according to claim 7, wherein the nickel alloy is nickel-chromium or nickel-vanadium, and the zinc alloy is zinc-aluminium.

19. The illuminated glazing element according to claim 8, wherein the corrosion protection layer has a thickness of 30 nm to 40 nm.

20. The method according to claim 15, wherein the illuminated glazing element is a vehicle roof pane.
